(19) United States
(12) Patent Application Publication
(10) Pub. No.: US 2019/0300304 A1
(43) Pub. Date: Oct. 3, 2019

(54) SHEET STORAGE DEVICE AND IMAGE FORMING APPARATUS

(71) Applicant: CANON KABUSHIKI KAISHA, Tokyo (JP)

(72) Inventors: Masaki Sato, Kawasaki-shi (JP); Shinta Cho, Kawasaki-shi (JP)

(21) Appl. No.: 16/352,573

(22) Filed: Mar. 13, 2019

(30) Foreign Application Priority Data
Mar. 30, 2018 (JP) 2018-068253
Oct. 30, 2018 (JP) 2018-204524

(51) Int. Cl. B65H 1/26; G03G 15/00

(52) U.S. Cl. CPC B65H 1/266; B65H 2511/10; G03G 15/6529

(57) ABSTRACT

A sheet storage device for storing sheets includes a supporting unit, a regulation unit, and a moving unit. The supporting unit supports stored sheets. The regulation unit is movably arranged on the supporting unit, and regulates a position of an edge portion of a sheet. The moving unit moves the regulation unit. The moving unit includes moving members to move in a direction parallel to a moving direction of the regulation unit. The moving members are moved by rotation of a rotation member in a case where the rotation member is in contact with the moving members. In a case where a fixing member attached to the sheet storage device in place of the rotation member, movement of the moving members is regulated by placing the moving members into contact with the fixing member.

### BACKGROUND OF THE INVENTION

### Field of the Invention

The present disclosure relates to a sheet storage device and an image forming apparatus.

### Description of the Related Art

A sheet storage device used for an image forming apparatus main body can store various sizes of sheets and regulate a position of sheets stacked on a stacking unit included in the sheet storage device.

A cassette unit attachable to and detachable from a main body of an image forming apparatus is known as one example of the sheet storage device. The cassette unit includes a regulation unit which regulates a position in a conveyance direction or a width direction of the sheets stacked on the stacking unit. A role of the regulation unit is to correctly regulate the position of the sheets stacked on the stacking unit to achieve an appropriate sheet conveyance operation. Since the sheets stacked on the stacking unit have a wide variety of sizes, the regulation unit needs to move depending on the sheet size.

The regulation unit includes an operation lever operated by a user or a serviceperson. By operating the operation lever, the user can release a fixed state of the regulation unit and move the regulation unit. Further, when the user stops operating the operation lever, the regulation unit is fixed to a position where the operation of the operation lever is stopped.

Japanese Patent Application Laid-Open No. 2016-113300 discusses a configuration in which an operation lever is arranged on the upper side of a regulation unit, which allows a user to easily recognize or operate the operation lever.

The regulation unit described in Japanese Patent Application Laid-Open No. 2016-113300 is moved by operating the operation lever.

Depending on the user, in order to use only regular size sheets, there are cases where the regulating unit is fixed. In some cases, the regulating unit is fixed so that the regulating unit does not move during transportation of the image forming apparatus.

### SUMMARY OF THE INVENTION

According to an aspect of the present disclosure, a sheet storage device for storing sheets includes a supporting unit configured to support stored sheets, a regulation unit movably arranged on the supporting unit, and configured to regulate a position of an edge portion of a sheet, and a moving unit configured to move the regulation unit, wherein the moving unit includes moving members configured to move in a direction parallel to a moving direction of the regulation unit, wherein the moving members are moved by rotation of a rotation member in a case where the rotation member is in contact with the moving members, and wherein, in a case where a fixing member is attached to the sheet storage device in place of the rotation member, movement of the moving members is regulated by placing the moving members into contact with the fixing member.

Further features of the present disclosure will become apparent from the following description of embodiments with reference to the attached drawings.

### BRIEF DESCRIPTION OF THE DRAWINGS

FIG. 1 is a cross-sectional diagram illustrating a configuration of an image forming apparatus.

FIG. 2A is a top plan diagram of a cassette detached from an apparatus main body. FIG. 2B is a top plan diagram of the cassette illustrated in FIG. 2A, from which an intermediate plate is removed.

FIG. 3A is an enlarged diagram illustrating a periphery of a rotation member illustrated in FIG. 2B. FIG. 3B is an enlarged diagram illustrating a state where a first fixing member is attached to the cassette in place of the rotation member illustrated in FIG. 3A.

FIGS. 4A, 4B, and 4C are enlarged diagrams illustrating other fixing members.

FIG. 5A is a perspective view illustrating a second fixing member. FIG. 5B is a perspective view illustrating a back face side of the second fixing member.

FIG. 6A is a top plan diagram of the supporting unit detached from the apparatus main body, and from which the intermediate plate is further removed. FIG. 6B is a partially enlarged diagram illustrating a peripheral area of an opening of the supporting unit.

FIG. 7A is a partially enlarged diagram illustrating a state where the second fixing member is attached to the supporting unit. FIG. 7B is a partially enlarged perspective diagram illustrating a state where the second fixing member is attached to the supporting unit.

FIG. 8A is a perspective diagram illustrating the supporting unit viewed from a back side. FIG. 8B is a partially enlarged diagram of the supporting unit illustrated in FIG. 8A.

FIG. 9A is an enlarged diagram illustrating a state where the second fixing member is attached and fixed to the supporting unit illustrated in FIG. 8A. FIG. 9B is a cross-sectional diagram illustrating a state where the second fixing member is attached and fixed to the supporting unit illustrated in FIG. 8A.

FIGS. 10A and 10B are enlarged diagrams illustrating other examples of the second fixing member.

FIG. 11A is an enlarged diagram illustrating an engaging claw included in the second fixing member. FIG. 11B is an enlarged diagram illustrating the second fixing member engaging with a moving member at a hole 1d of the supporting unit different from a hole 1c of the supporting unit.

FIG. 12 is an enlarged diagram illustrating another example of the second fixing member.

### DESCRIPTION OF THE EMBODIMENTS

A first embodiment of the present disclosure will be described below with reference to the drawings. However, sizes, materials, shapes, and relative positions of constituent elements described in the present embodiment should be changed as appropriate according to the configuration or various conditions of the apparatus to which the present disclosure is applied. Thus, the scope of the present disclosure should not be limited to the below-described embodiment.

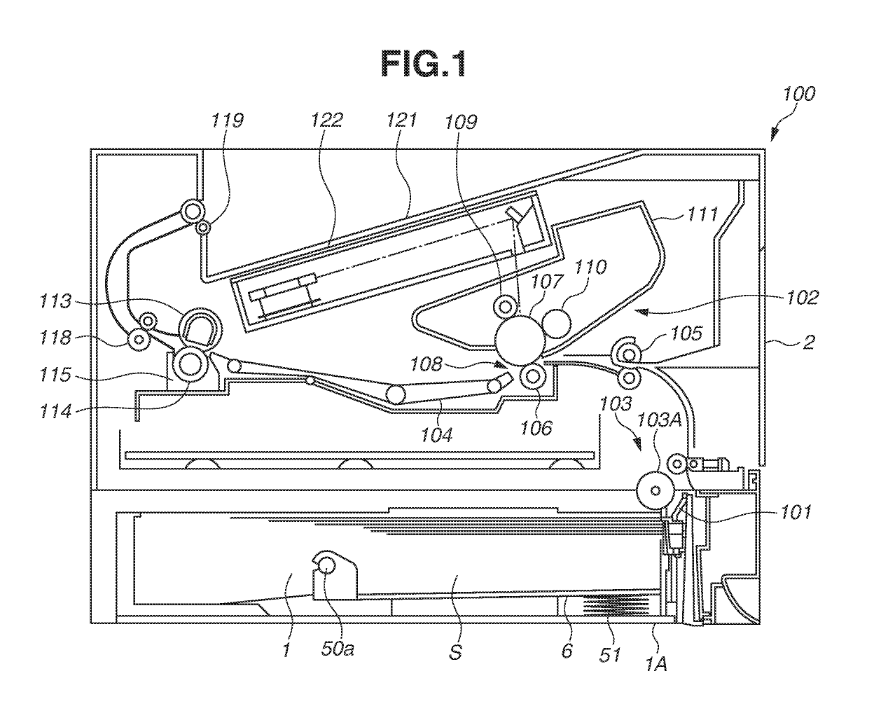

FIG. 1 is a cross-sectional diagram illustrating a configuration of a color electrophotographic type image forming apparatus 100. The present disclosure is not limited to the image forming apparatus 100 employing the electrophotographic processing. The present disclosure is also applicable to an age forming apparatus of another type, e.g., a printer employing ink-jet image forming processing.

As illustrated in FIG. 1, the image forming apparatus 100 includes an apparatus main body 2, an image forming unit 102 that forms an image through an electrophotographic method, and a sheet feeding device 103 that feeds a sheet S to the image forming unit 102.

The image forming unit 102 includes a photosensitive drum 107 for forming a toner image, a charging roller 109 for uniformly charging a surface of the photosensitive drum 107, and a development unit 110 for supplying toner to the photosensitive drum 107.

The sheet feeding device 103 includes a cassette 1 serving as a sheet storage device, which is capable of storing a plurality of sheets S, and a feeding roller 103A serving as a feeding member, which is arranged on the upper side of the cassette 1 and feeds the sheets S stored in the cassette 1.

The cassette 1 includes a cassette main body 1A for storing the sheets S and a stacking member. An intermediate plate 6 serving as the stacking member, on which the sheets S are stacked, is held in a freely rotatable state in the upper and lower directions without meaningful restriction by making a shaft 50a included in the cassette main body 1A as a supporting point and biased to the feeding roller 103A by a coil spring 51. The intermediate plate 6 stacks a plurality of sheets S.

The cassette main body 1A includes a supporting unit for supporting the sheets S, and includes a bottom face portion that constitutes an exterior face of the cassette main body 1A. The intermediate plate 6 serving as the stacking member is pushed up by the coil spring 51 in a direction of the feeding roller 103A, so that the sheets S stacked on the intermediate plate 6 is pressed against the feeding roller 103A. Further, in this cassette 1, a separation unit 101 for separating the sheets S fed by the feeding roller 103A one by one is provided.

Next, an image forming operation performed by the image forming apparatus 100 will be described. First, based on an image signal from a host computer (not illustrated), a laser scanner 122 serving as an exposure unit emits laser light on the photosensitive drum 107. A surface of the photosensitive drum 107 is previously charged by the charging roller 109 in advance, and the photosensitive drum 107 rotates in a clockwise direction. With this configuration, an electrostatic latent image is formed on the surface of the photosensitive drum 107. The electrostatic latent image formed on the surface of the photosensitive drum 107 is developed with toner on the development unit 110, and thus a toner image is formed on the photosensitive drum 107.

On the other hand, the feeding roller 103A starts rotating at a predetermined timing, and the intermediate plate 6 biased to a side of the feeding roller 103A by the coil spring 51 is rotationally moved upward interlocking with the rotation of the feeding roller 103A. Accordingly, a leading edge portion of the sheet S stacked on the intermediate plate 6 is pressed to contact the feeding roller 103A with a predetermined force. At this time, the feeding roller 103A is controlled to rotate in a counter-clockwise direction only when the sheet S is fed thereby, and the sheet S in a press-contact state is fed by a frictional force. If a plurality of sheets S stacked on the intermediate plate 6 is fed simultaneously, only an uppermost sheet of the sheets S is separated and conveyed downstream by the separation unit 101.

The uppermost sheet S separated by the separation unit 101 is conveyed to a skew correction unit 105, and skew correction is executed thereon. Thereafter, the sheet S is conveyed to a transfer portion 108 consisting of the photosensitive drum 107 and a transfer roller 106 by the skew correction unit 105. As described above, a toner image formed on the photosensitive drum 107 is electrically attracted and transferred to the sheet S by the transfer roller 106.

The sheet S on which the toner image is transferred is conveyed to a fixing unit 115 configured of a heating unit 113 and a pressure roller 114 by a conveyance belt 104, and heat and pressure are applied thereto at the fixing unit 115 and thus, the toner image is fixed to the sheet S. Then, the sheet S is discharged, by an intermediate discharge roller pair 118 and a discharge roller pair 119, onto a sheet discharge tray 121 arranged on the upper face of the apparatus main body 2.

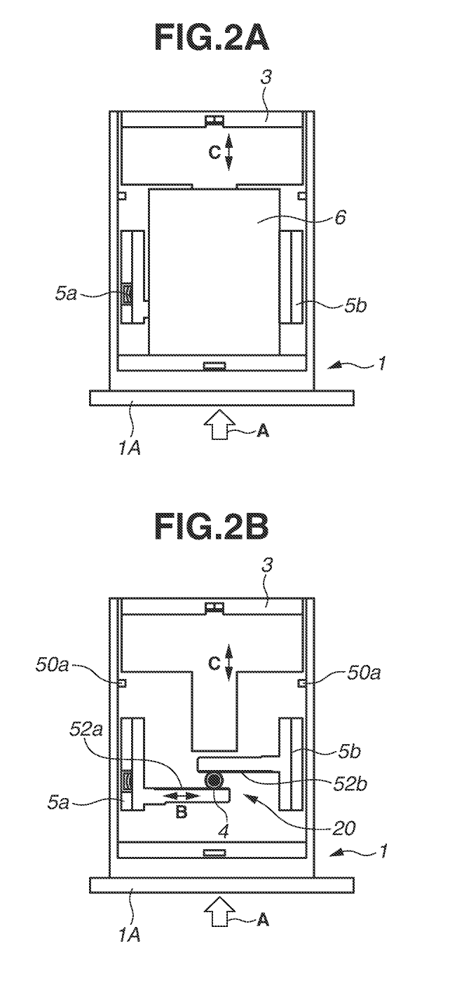

Next, a configuration of the cassette 1 will be described with reference to FIGS. 2A and 2B. FIG. 2A is a top plan diagram of the cassette 1 removed from the apparatus main body 2. FIG. 2B is a top plan diagram of the cassette 1 illustrated in FIG. 2A, from which the intermediate plate 6 is removed. A configuration of a cassette main body will be described with reference to FIGS. 2A and 2B. FIGS. 2A and 2B are diagrams illustrating an inner portion of the cassette 1. In a state where the cassette 1 is attached to the apparatus main body 2, an arrow-A direction of the cassette 1 is the sheet conveyance direction.

The cassette 1 includes a cassette main body 1A for storing sheets of various sizes, regulation units 5a, 5b, and 3 for regulating positions of edge portions of the sheets S supported by the cassette main body 1A, and the intermediate plate 6. The regulation unit includes a rear-edge regulation member 3 and width regulation members 5a and 5b. The rear-edge regulation member 3 abuts on the rear edge of the sheet in the sheet conveyance direction to regulate a position of the rear edge. The width regulation members 5a and 5b regulate a position of the sheet in the width direction intersecting with the sheet conveyance direction. The width regulation members 5a and 5b and the rear-edge regulation member 3 are arranged so as not to have an influence on rotational movement of the intermediate plate 6 illustrated in FIG. 1.

In the present embodiment, because a sheet feeding apparatus and an image forming apparatus are integrally configured as the image forming apparatus 100, the cassette 1 is attachable to and detachable from the image forming apparatus 100. However, in a configuration in which the sheet feeding apparatus is arranged independently from the image forming apparatus, the cassette 1 is attachable to and detachable from the sheet feeding apparatus. Conventionally, an option feeder attachable to the image forming apparatus 100 is an example of a sheet feeding apparatus.

When a plurality of sheets S is to be stored in the cassette 1, the side edge positions of the sheets S are regulated by making the width regulation members 5a and 5b abut on the side edges of the sheets 5, whereas the rear edge positions of the sheets S are regulated by making the rear-edge regulation member 3 abut on the rear edges of the sheets S after the sheets S are placed on the intermediate plate 6. Thus, the sheets S are positioned and stored therein. Next, the cassette 1 is attached to the image forming apparatus 100, and the sheets S are fed one by one by the feeding roller 103A.

When the cassette 1 is attached thereto, the intermediate plate 6 illustrated in FIG. 1 is pushed upward by the coil spring 51 illustrated in FIG. 1 by making the shaft 50a as a center. With this configuration, the sheets S positioned by the width regulation members 5a and 5b and the rear-edge regulation member 3 are pressed against the feeding roller 103A illustrated in FIG. 1. The sheets S pressed against the feeding roller 103A are fed by the feeding function of the feeding roller 103A one by one, and fed to the image forming unit 102 illustrated in FIG. 1.

A moving unit 20 that moves the width regulation members 5a and 5b in the width direction is arranged on the cassette main body 1A. The moving unit 20 includes rack portions 52a and 52b serving as moving members movable in a direction parallel to the moving direction of the width regulation members 5a and 5b and a pinion gear 4 serving as a rotation member. Specifically, the rack portions 52a and 52b, which extend in an arrow-B direction, i.e., a direction the same as the width direction or the moving direction of the width regulation members 5a and 5b, are respectively arranged at the lower portions of the width regulation members 5a and 5b as a pair as illustrated in FIG. 2B. The rack portions 52a and 52b are guided by guide grooves (not illustrated) provided on the bottom plate of the cassette main body 1A in the arrow-B direction and freely movable without meaningful restriction in the width direction. Further, the rack portions 52a and 52b includes rack gears that engage with the rotatable pinion gear 4.

The pinion gear 4 serving as a rotation member, which is freely rotatable about a shaft portion without meaningful restriction, is arranged at the center of the bottom face portion of the cassette main body 1A. The pinion gear 4 has a gear shape, and is attachable to and detachable from the cassette main body 1A. The teeth formed on the rack portions 52a and 52b engage with the pinion gear 4. With this configuration, because of the function of the pinion gear 4 and the rack portions 52a and 52b, when one of the width regulation members 5a and 5b moves in the width direction (i.e., first direction), the other of the width regulation members 5a and 5b cooperatively moves in a direction (i.e., second direction) opposite to the direction of the one of the width regulation members 5a and 5b. As described above, both of the width regulation members 5a and 5b simultaneously move in the width direction to abut on the side edges of the sheets stacked on the intermediate plate 6 by moving one of the width regulation members 5a and 5b, so that positioning of the sheets in the width direction can be executed easily.

The rear-edge regulation member 3 is guided by a guide groove (not illustrated) provided on the bottom plate of the cassette main body 1A in an arrow-C direction, and freely movable without meaningful restriction in the sheet feeding direction. As described above, the width regulation members 5a and 5b can freely move without meaningful restriction depending on a size of stacked sheets.

As described above, a user may fix the width regulation members 5a and 5b because the user uses only a sheet of a predetermined standard size. Further, there is a case where the width regulation members 5a and 5b are fixed at the time of transportation of the image forming apparatus 100. In the present embodiment, the width regulation members 5a and 5b are fixed with a simple configuration by utilizing the moving unit 20.

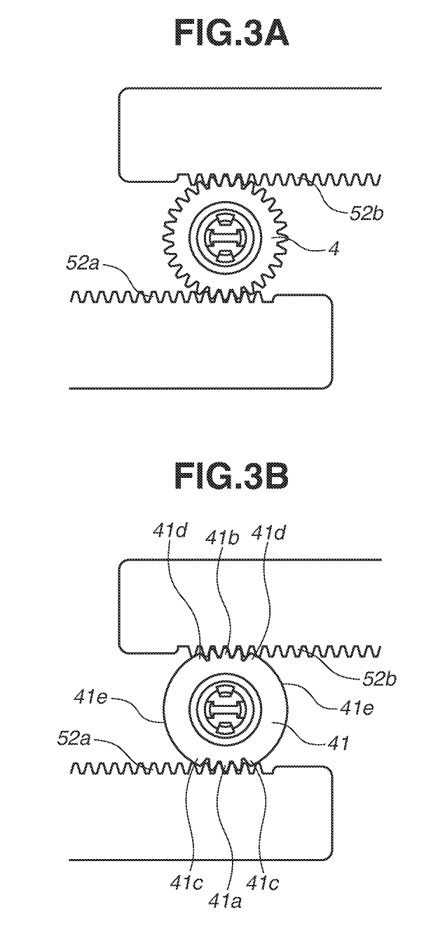

FIG. 3A is an enlarged diagram illustrating a periphery of the pinion gear 4 illustrated in FIG. 2B. FIG. 3B is an enlarged diagram illustrating a state where a first fixing member 41 is attached to the cassette main body 1A in place of the pinion gear 4. A method of attaching the first fixing member 41 will be described below. First, the intermediate plate 6 illustrated in FIG. 1 is removed from the cassette 1. Next, the width regulation members 5a and 5b are moved to a desired or predetermined position. The pinion gear 4 is removed in a state where the width regulation members 5a and 5b are positioned. Positioning of the width regulation members 5a and 5b may be executed before the intermediate plate 6 is removed. In this case, standard size sheets are set in the cassette 1, and positioning of the width regulation members 5a and 5b may be executed by abutting the width regulation members 5a and 5b on the sheets.

Next, the stopper 41 serving as the first fixing member illustrated in FIG. 3B is attached to a position where the pinion gear 4 has been attached. Lastly, the intermediate plate 6 is attached. As described above, teeth 41a of the stopper 41 engage with the rack portion 52a, whereas teeth 41b of the stopper 41 similarly engage with the rack portion 52b on the opposite side. Then, outer edge portions 41c of the non-engaging portion of the stopper 41 are in contact with the rack portion 52a. Similarly, outer edge portions 41d of the non-engaging portion of the stopper 41 on the opposite side are in contact with the rack portion 52b facing thereto. And thus, movement of the rack portions 52a and 52b is restricted and movement of the width regulation member 5a and 5b are fixed.

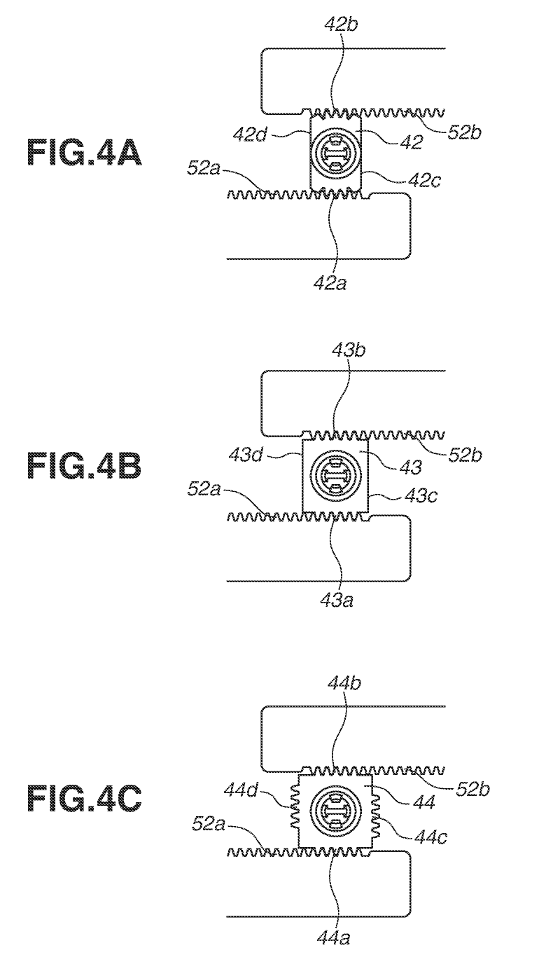

As described above, although the stopper 41 includes the arc-shaped outer edge portion 41d as a non-engaging portion, the stopper 41 may be formed into another shape. For example, the first fixing members having the shapes illustrated in FIGS. 4A to 4C may be also used. FIG. 4A is a cross-sectional diagram illustrating a stopper 42 and linear-shaped portions 42c and 42d of the stopper 12. FIG. 4B is a cross-sectional diagram illustrating a stopper 43 and linear-shaped portions 43c and 43d of the stopper 43. Teeth 42a and 42b of the engaging portion of the stopper 42 are arranged linearly, and the linear-shaped portions 42c and 42d without having teeth serve as the non-engaging portions. Similarly, teeth 43a and 43b of the engaging portion of the stopper 43 are arranged linearly, and the linear-shaped portions 43c and 43d without having teeth serve as the non-engaging portions. Because the teeth of the engaging portion are arranged linearly, rattling arising in the fixed width regulation members 5a and 5b will be less in comparison to the case of the arc-shaped stopper. On the other hand, for example, if a phase of the rack portions 52a and 52b becomes different in Letter size and A4 size, stoppers adjusted to different phases will be needed as illustrated in FIGS. 4A and 4B.

Further, as illustrated in FIG. 4C, teeth 44a and 44b are linearly arranged on the engaging portion of the stopper 44 similarly with the teeth 43a and 43b illustrated in FIG. 4B, and teeth 44c and 44d are also arranged on non-engaging portions. For example, the teeth 44a and 44b are arranged on the engaging portions dedicated for Letter size, whereas the teeth 44c and 44d are arranged on the engaging portions dedicated for A4 size. Then, the phase of the teeth dedicated for Letter size is shifted from the phase of the teeth dedicated for A4 size, so that a single stopper can manage a situation in which the phases of the rack portions 52a and 52b for Letter size and A4 size are different.

Further, a front face of the stopper may be formed into a shape of the pinion gear 4 as illustrated in FIG. 3A, whereas a back face thereof may be formed into a shape as illustrated in FIG. 3B. With this configuration, the pinion gear 4 and the stopper 41, 42, or 43 are formed of a single component. Thus, fixation or non-fixation of the width regulation members 5a and 5b are managed with a single component by attaching the component thereto with a front and a back faces thereof being inverted.

Further, a housing portion dedicated for housing the stopper 41 (or stopper 42 or 43) may be provided on the cassette main body 1A. In this case, the pinion gear 4 is attached to the cassette main body 1A, and the stopper 41 is taken out from the housing portion and used when the width regulation members 5a and 5b are fixed.

As described above, in the present embodiment, the width regulation members 5a and 5b are fixed by utilizing the constituent elements included in the moving unit 20. Therefore, screw holes dedicated for fixing the width regulation members 5a and 5b do not have to be provided on the cassette main body 1A. Further, the stopper 41 (or stopper 42 or 43) cannot be detached easily because the stopper 41 is thoroughly covered by the intermediate plate 6 in a manner that is thorough or complete.

According to the configuration described in the first embodiment, the stopper 41 serving as the first fixing member is attached to the central portion of the bottom face of the cassette main body 1A in place of the pinion gear 4, and the width regulation members 5a and 5b are fixed thereby. According to the configuration described in the second embodiment, the width regulation members 5a and 5b are fixed without removing the pinion gear 4 from the cassette main body 1A. A reference numeral the same as that of the first embodiment will be applied to the configuration similar to the configuration described in the first embodiment.

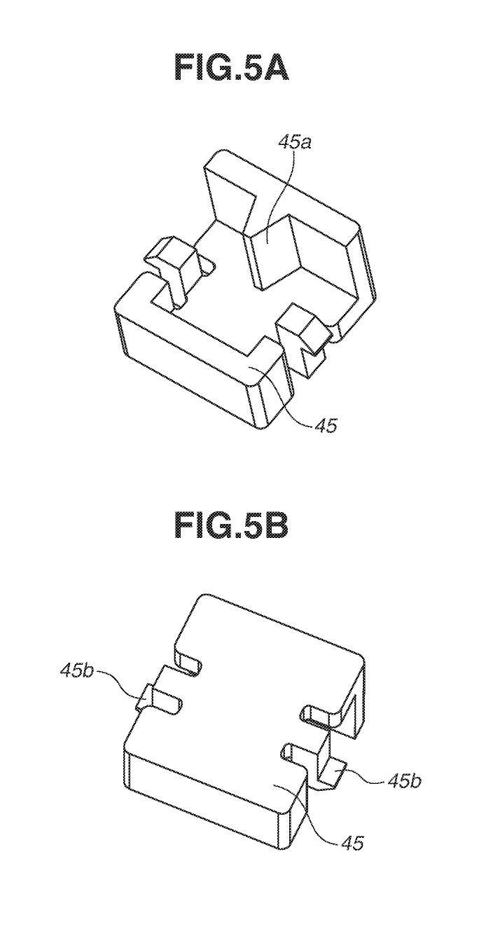

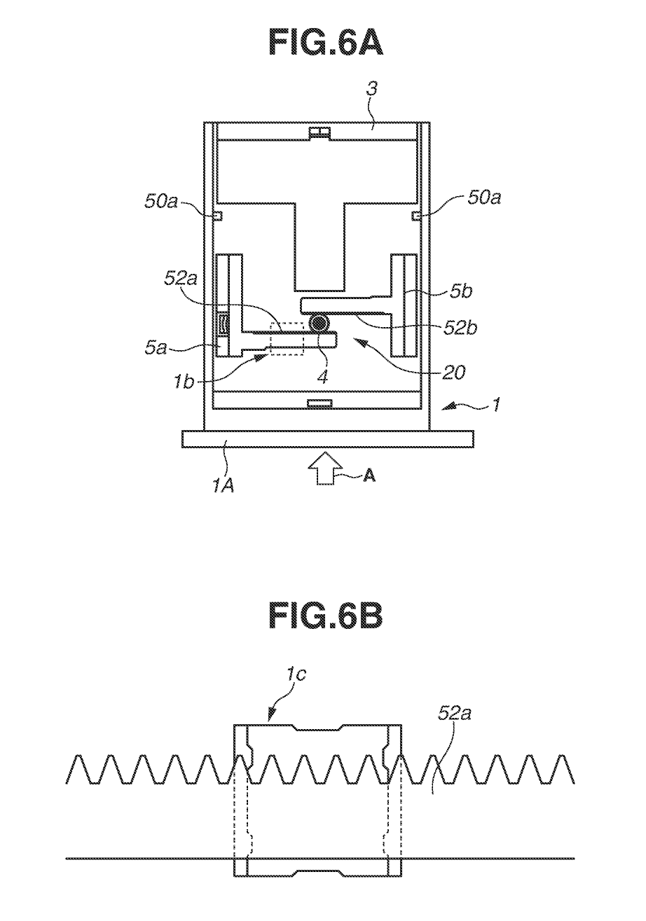

FIGS. 5A and 5B are perspective views illustrating a stopper 45 as the second fixing member. Further, FIG. 6A is a top plan diagram of the cassette main body 1A detached from the apparatus main body, from which the intermediate plate 6 is further removed. FIG. 6B is a partially enlarged diagram illustrating a peripheral area 1b of a hole 1c of the cassette main body 1A illustrated in FIG. 6A. The hole 1c of the cassette main body 1A will be described below.

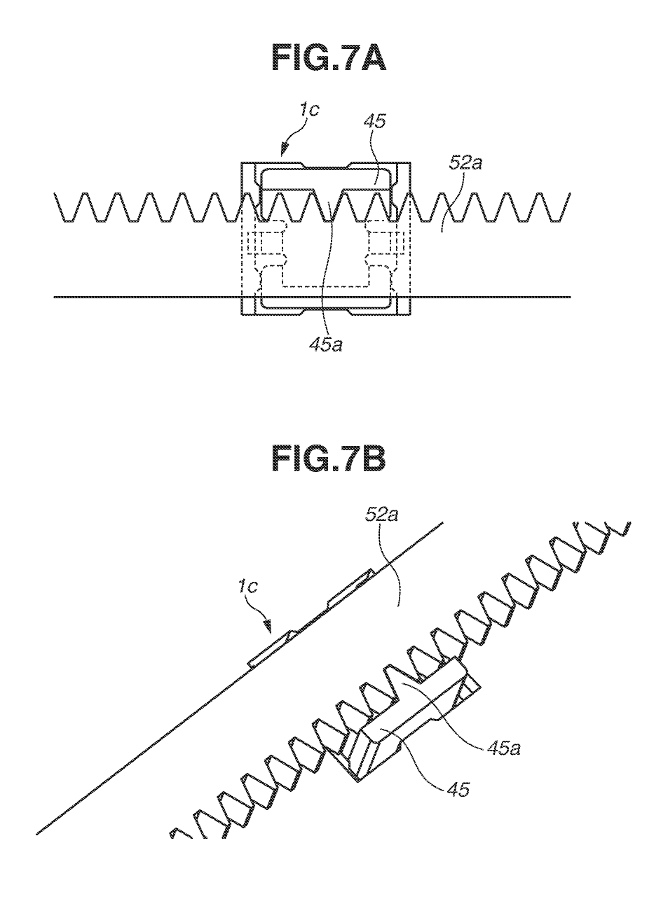

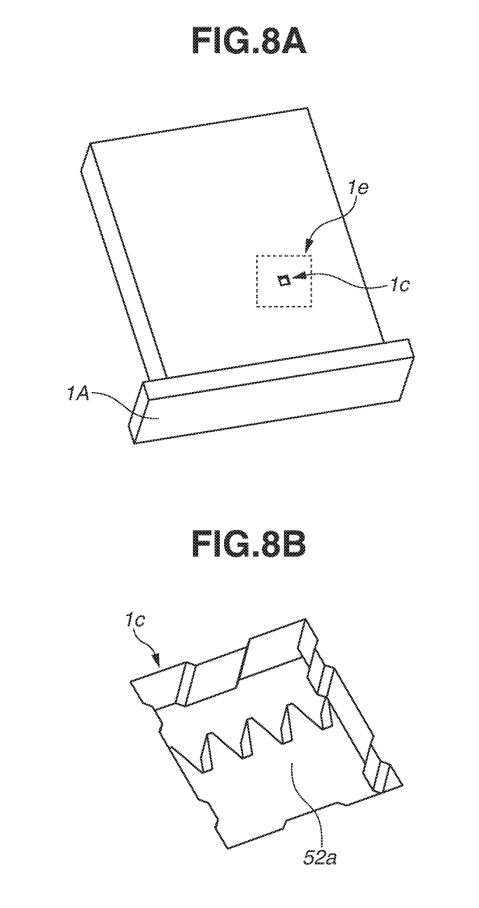

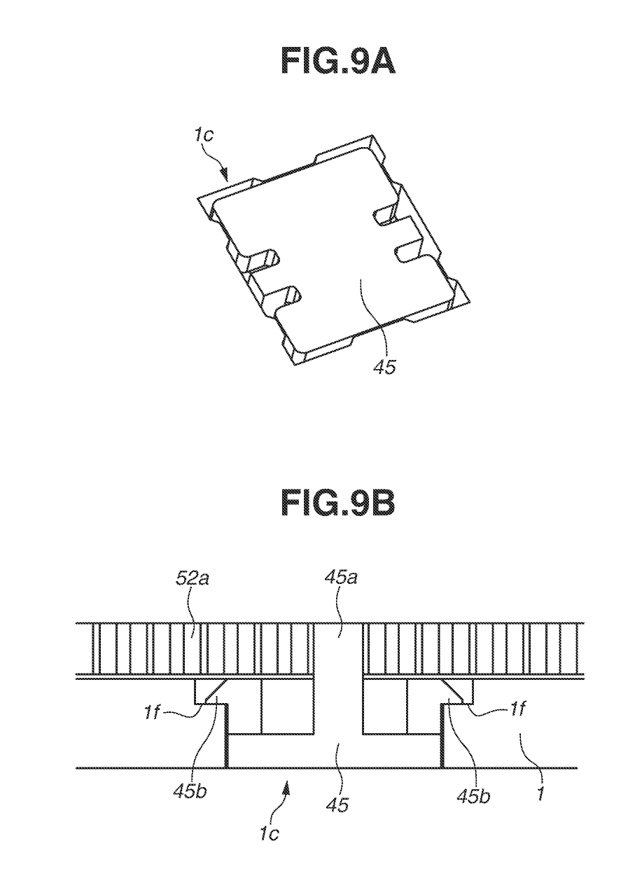

FIG. 7A is a partially enlarged diagram illustrating a state where the stopper 45 is attached to the hole 1c of the cassette main body 1A. FIG. 7B is a perspective diagram of the partially enlarged diagram illustrating a state where the stopper 45 is attached to the hole 1c of the cassette main body 1A. FIG. 8A is a perspective diagram illustrating the cassette main body 1A viewed from a back side. FIG. 8B is a partially enlarged diagram of the cassette main body 1A illustrated in FIG. 8A. FIG. 9A is an enlarged diagram illustrating a state where the stopper 45 is attached and fixed to the cassette main body 1A illustrated in FIG. 8A. FIG. 9B is a cross-sectional diagram illustrating a state where the stopper 45 is attached and fixed thereto.

The stopper 45 according to the present embodiment will be described. The stopper 45 is formed of a resinous material. In the present embodiment, a color the same as a color used for the back face of the cassette main body 1A is used for the stopper 45. By using the same color, the stopper 45 becomes visually less recognizable. And thus, a chance of the user removing the stopper 45 therefrom is reduced.

Depending on the intended or predetermined use, a color different from the color of the cassette main body 1A may be used so as to make the stopper 45 be more visually recognizable. FIG. 5A is a diagram illustrating an attaching face of the stopper 45. The stopper 45 includes a claw 45a serving as an engaging claw. FIG. 5B is a diagram illustrating a rear face of the stopper 45. The stopper 45 includes a latching claw 45b serving as a latching portion.

In the present embodiment, the intermediate plate 6 illustrated in FIG. 1 need not to be removed from the cassette 1 when the stopper 45 is to be attached. As illustrated in FIG. 8A, the stopper 45 is directly attached to a hole 1c, which is an opening provided on the cassette main body 1A, from the rear face of the cassette main body 1A. The hole 1c is provided to penetrate through the cassette main body 1A. When the cassette 1 is attached to the apparatus main body 2, a side of the bottom face of the cassette main body 1A is regarded as a rear face side of the cassette 1, and a side opposite to the rear face side is regarded as a front face side thereof.

When the stopper 45 is to be attached thereto, firstly, the width regulation members 5a and 5b are moved to desired or predetermined positions. Then, the stopper 45 is attached to the cassette main body 1A from the rear face side of the cassette 1 via the hole 1c. In this state, as illustrated in FIGS. 7A and 7B, the claw 45a of the stopper 45 engages with the rack portion 52a, so that the movement of the rack portion 52a is fixed by the stopper 45. As illustrated in FIG. 9A, when the cassette main body 1A is viewed from the rear face side in a state where the stopper 45 is attached, the latching claw 45b of the stopper 45 enters into an inner portion of the cassette main body 1A.

Through the above-described configuration, movement of the rack portion 52a that engages with the claw 45a of the stopper 45 is regulated. In parallel, movement of the pinion gear 4 and the rack portion 52b cooperating with the rack portion 52a is also regulated, so that the width regulation members 5a and 5b are fixed. A direction from which the stopper 45 is inserted is not limited to from the rear face side of the cassette 1, and the stopper 45 may be inserted from the front face side of the cassette 1. In this case, similar to the first embodiment, the stopper 45 may be attached after removal of the intermediate plate 6. Further, in order to insert the stopper 45 into the cassette 1 without removing the intermediate plate 6, a hole having an optional shape and size may be formed on the intermediate plate 6. In a case where the hole is formed on the intermediate plate 6, a position of the intermediate plate 6 is also fixed with the stopper 45.

A rack portion which the stopper 45 engages with is not limited to the rack portion 52a. If the rack portions 52a and 52b cooperate with each other, the stopper 45 may engage with the rack portion 52b. However, more appropriate position of the hole 1c is determined in the cassette main body 1A, in which the sheets S are stored, depending on whether an alignment reference of the sheets S is the left edge (i.e., a side of the rack portion 52a) or the right edge (i.e., a side of the rack portion 52b). A tolerance is reduced in a case where a distance between the alignment reference of the sheets S and the fixing position of the width regulation member 5a or 5b is shorter. Accordingly, if the alignment reference of the sheets S is the left edge, the hole 1c should be formed so as to make the rack portion 52a engage with the stopper 45. If the alignment reference thereof is the right edge, the hole 1c should be formed so as to make the rack portion 52b engage with the stopper 45.

In a case where the rack portions 52a and 52b do not interlock with each other, movement of the width regulation members 5a and 5b are fixed by making both of the rack portions 52a and 52b engage with the stoppers 45. In this case, hole 1c serving as opening portions may be formed at corresponding two positions.

FIG. 9B is a cross-sectional diagram illustrating a state where the stopper 45 is attached to the cassette main body 1A. The stopper 45 can latch with the inner portion of the hole 1c of the cassette main body 1A with the latching claw 45b serving as a latching portion of the stopper 45. Because the latching claw 45b of the stopper 45 latches with a locking portion 1f provided on the hole 1c of the cassette main body 1A, an attached state of the stopper 45 with respect to the cassette main body 1A is maintained. Because the rack portion 52a is fixed thereby, the width regulation members 5a and 5b cannot be moved even if the user tries to move the width regulation members 5a and 5b. In the present embodiment, although the stopper 45 is attached to the cassette main body 1A through the latching claw 45b, an attaching method is not limited thereto. Another attaching method such as a press-fit method or an adhesive-joining method may also be used.

In the present embodiment, a grip portion is not provided on the rear face side of the stopper 45, so that the stopper 45 cannot be easily detached from the cassette main body 1A. With this configuration, the user cannot easily detach the stopper 45. However, the stopper 45 may desirably be detached easily with respect to the user who would like to fix the width regulation members 5a and 5b only at a time of transportation of the image forming apparatus 100. In this case, for example, a grip portion protruding from the hole 1c may be provided on the rear face of the stopper 45, so that the user can easily detach the stopper 45 from the cassette main body 1A by using the grip portion.

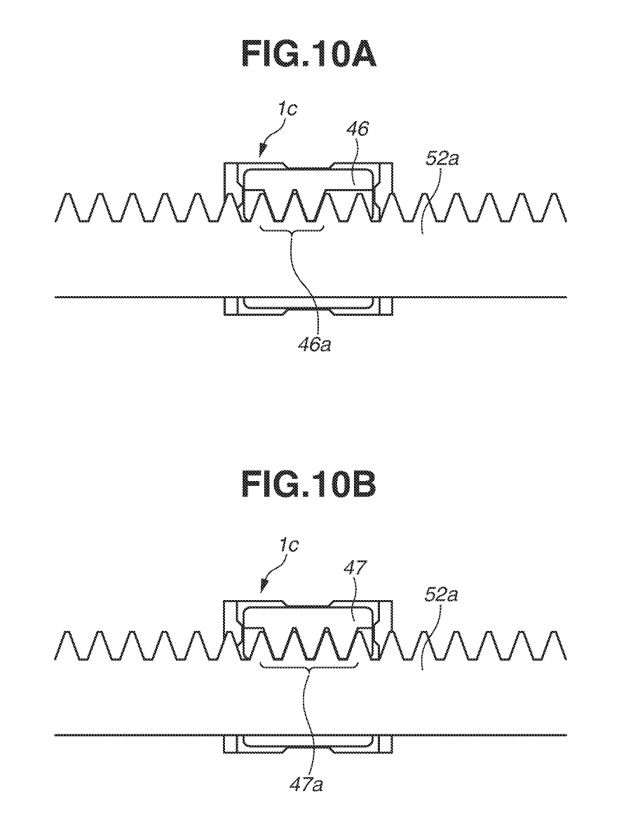

The stopper 45 may be formed into another shape. For example, as illustrated in FIGS. 10A and 10B, a plurality of engaging claws as fixing portions may be arranged on the stopper 46 and 47 serving as the second fixing member. The stopper 46 illustrated in FIG. 10A includes two engaging claws 46a. The stopper 47 illustrated in FIG. 10B includes three engaging claws 47a. As described above, although the second fixing member that engages with the rack portion 52a may include at least one engaging claw, the number of engaging claws may be more than one. Further, if the number of engaging claws is greater, strength of the engaging portion with respect to the rack portion 52a will be increased and thus the force for fixing and retaining the width regulation members 5a and 5b is improved.

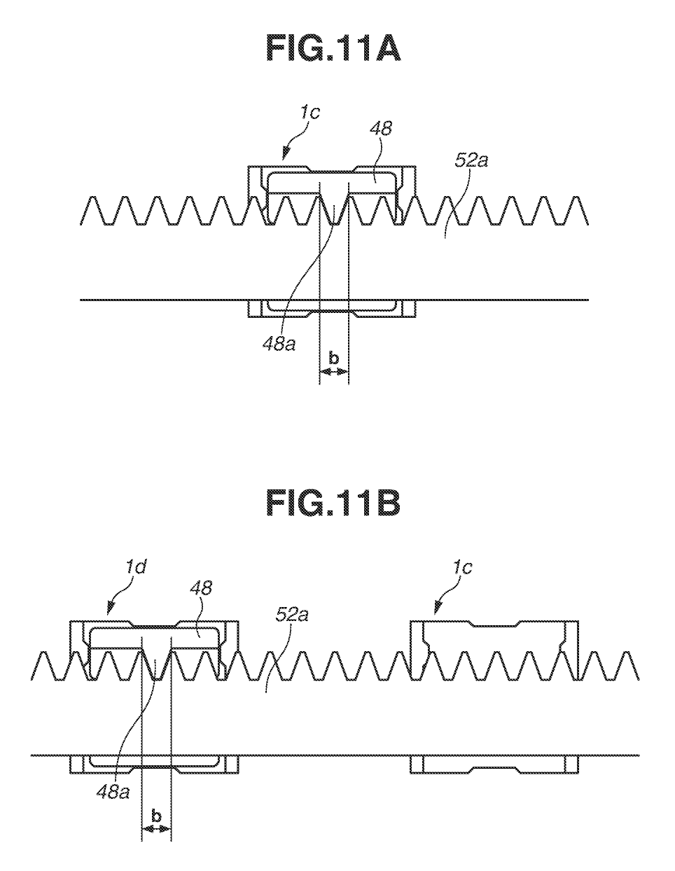

In a case where a size of the sheet regulated by the width regulation members 5a and 5b is determined when the width regulation members 5a and 5b are used in a fixed state, a width of the engaging claw may be specified. FIG. 11A is an enlarged diagram illustrating a stopper 48 as the second fixing member and an engaging claw 48a included in the stopper 48. With respect to the stopper 48, a size of a width b of the engaging claw 48a is specified. Specifically, the width b is specified as a value by which 6 mm is dividable, e.g., 3 mm, 2 mm, 1 mm, or 0.5 mm.

The “6 mm” above represents a difference between the width 216 mm of Letter size sheet and the width 210 mm of A4 size sheet. By specifying the value of the width b of the engaging claw 48a as an interval by which the difference 6 mm is dividable, the stopper 48 can fix the width regulation members 5a and 5b while minimizing a gap arising when the sheets of respective sizes, i.e., Letter size and A4 size, are fixed.

Since the width b is specified with respect to the member that regulates the widths of Letter size sheets and A4 size sheets conveyed in a portrait orientation, the width b is specified as a value by which the difference 6 mm is dividable. However, if fixation of sheets of different types having the widths other than the above-described widths is to be achieved, the value of width b has to be specified as a value by which a difference of sheets of all types regarded as fixation targets is dividable. By satisfying the above-described condition, the stopper 48 can manage fixation of sheets of greater variation. Similarly, a width of the claw of the rack portion 52a has to be specified in accordance with the size of the width b.

FIG. 11B is an enlarged diagram illustrating the stopper 48 which engages with the rack portion 52a at a hole 1d of the cassette main body 1A, which is different from the hole 1c of the cassette main body 1A. The stopper 48 is inserted into two places, the holes 1c and 1d, of the cassette main body 1A. Thus, a degree of freedom in fixing the width regulation members 5a and 5b is improved. If a phase of hole position with respect to the rack portion 52a is shifted between the holes 1c and 1d of the cassette main body 1A, a fixing unit for engaging with any one of the holes 1c and 1d of the cassette main body 1A is provided. In particular, by shifting the phase of hole positions of the hole 1c and the hole 1d of the cassette main body 1A by half a pitch of the claw with respect to the rack portion 52a, a degree of freedom is improved efficiently, so that sheets of different types with greater variation of widths are managed thereby. Further, the stopper 48 is inserted to the hole 1c of the cassette main body 1A when Letter size sheet is to be fixed, and the stopper 48 is inserted to the hole 1d of the cassette main body 1A when A4 size sheet is to be fixed. As described above, usability is improved by changing the insertion position. Further, the stopper 48 can engage with the rack portion 52b through the hole 1d of the cassette main body 1A instead of engaging with the rack portion 52a.

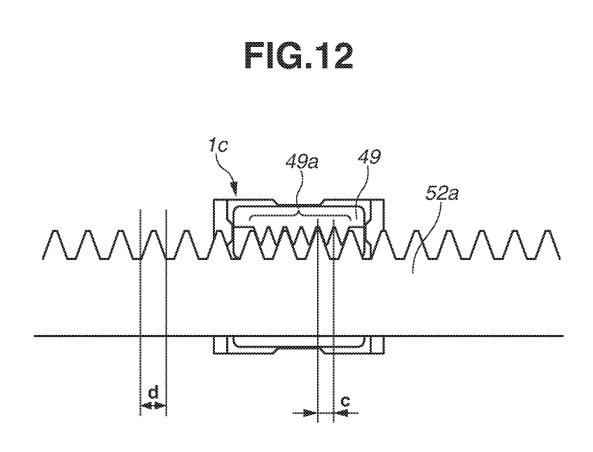

FIG. 12 is a partially enlarged diagram illustrating a stopper 49 serving as a second fixing member which includes an engaging claw having a width shorter than a width (i.e., pitch distance) of a rack gear of the rack portion 52a serving as a portion with which the engaging claw engages. A width c of the stopper 49 is smaller than the width d of the claw of the rack portion 52a, and the width c is a value by which the width d is dividable. With this configuration, the stopper 49 can fix the rack portion 52a while minimizing the gap when the engaging claw engages therewith. However, if the width c of the claw 49a of the stopper 49 is selected to be too small, an engaging amount of the claw is also reduced, so that the claw may be disengaged easily. Accordingly, a width that is half the width d of the claw of the rack portion 52a, which serves as a portion with which the engaging claw engages, should be appropriate for the width c of the claw 49a of the stopper 49.

Providing a plurality of claws 49a on the stopper 49 compensates lowering of strength caused by reduction in size of the claw 49a. Further, a relationship between the claw 49a of the stopper 49 and the claw of the rack portion 52a may be reversed. In other words, the width d of the claw of the rack portion 52a may be specified as a value by which the width c of the claw 49a of the stopper 49 is dividable.

A housing portion dedicated for housing the stopper 45 (or the stopper 46, 47, 48, or 49) may be provided on the cassette main body 1A. In this case, the stopper 45 is not attached to the cassette main body 1A, and the stopper 45 is taken out from the housing portion and used when the width regulation members 5a and 5b are fixed.

In the present embodiment, although a method for fixing the width regulation members 5a and 5b has been described, the same configuration is used not only for the width regulation member but also for the rear-edge regulation member.

Further, a combination use of the first fixing member 41 in the first embodiment and the second fixing member in the present embodiment is also possible. In the configuration described in the first embodiment, since the first fixing member 41 is not exposed externally, the user has to remove the intermediate plate 6 in order to check whether the first fixing member 41 is in use. In the combination use, the user can visually recognize the stopper 45 if the hole 1c is formed on the rear face side of the cassette main body 1A. The user can recognize that the width regulation members 5a and 5b are fixed by visually recognizing the stopper 45, so that the user need not to remove the intermediate plate 6 to check the stopper 45.

As described above, in the present embodiment, the width regulation members 5a and 5b are fixed by utilizing the constituent elements included in the moving unit 20. Therefore, the width regulation members 5a and 5b are fixed at optional positions without using the screws and screw holes, which is discussed in Japanese Patent Application Laid-Open No. 2016-113300. The optional positions may be, for example, the positions corresponding to a sheet in a non-standard size.

According to the present embodiment, by attaching the stopper 45 to the hole 1c formed on the cassette main body 1A, it is possible to provide a sheet storage device in which the width regulation members 5a and 5b are fixed more easily than the conventional configuration.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Applications No. 2018-068253, filed Mar. 30, 2018, and No. 2018-204524, filed Oct. 30, 2018, which are hereby incorporated by reference herein in their entirety.

What is claimed is:

1. A sheet storage device for storing sheets, the sheet storage device comprising:
a supporting unit configured to support stored sheets;
a regulation unit movably arranged on the supporting unit, and configured to regulate a position of an edge portion of a sheet; and
a moving unit configured to move the regulation unit,
wherein the moving unit includes moving members configured to move in a direction parallel to a moving direction of the regulation unit,
wherein the moving members are moved by rotation of a rotation member in a case where the rotation member is in contact with the moving members, and
wherein, in a case where a fixing member is attached to the sheet storage device in place of the rotation member, movement of the moving members is regulated by placing the moving members into contact with the fixing member.

2. The sheet storage device according to claim 1,
wherein the moving unit includes a first moving member and a second moving member as the moving members, and
wherein the first moving member and the second moving member are mutually moved in opposite directions in an interlocking manner through rotation of the rotation member.

3. The sheet storage device according to claim 2,
wherein the regulation unit includes a first regulation member fixed to the first moving member and a second regulation member fixed to the second moving member, and
wherein the first regulation member and the second regulation member regulate positions of edge portions of a sheet in a width direction intersecting with a sheet-feeding direction of the sheet supported by the supporting unit.

4. The sheet storage device according to claim 3 further comprising a stacking member configured to stack the sheets supported by the supporting unit,
wherein the stacking member is arranged to cover the first moving member and the second moving member in a first direction, and
wherein the stacking member completely covers the rotation member in the first direction in a case where the rotation member is attached to the sheet storage device, and completely covers the fixing member in the first direction in a case where the fixing member is attached to the sheet storage device.

5. The sheet storage device according to claim 2,
wherein each of the first moving member and the second moving member has a gear-shaped portion, and
wherein the rotation member is configured to rotate in engagement with the gear-shaped portion.

6. The sheet storage device according to claim 5,
wherein the fixing member includes a non-engaging portion which does not engage with the gear-shaped portion, and
wherein movement of the first moving member and the second moving member are regulated by abutting the non-engaging portion on the gear-shaped portion.

7. The sheet storage device according to claim 1, further comprising a housing unit configured to house the fixing member in a state where the rotation member is attached to the sheet storage device.

8. An image forming apparatus, comprising:
an image forming unit configured to form a toner image;
a feeding member configured to feed a sheet to the image forming unit; and
the sheet storage device according to claim 1, configured to store the sheet fed by the feeding member.

9. A sheet storage device for storing a sheet, the sheet storage device comprising:
a supporting unit configured to support a stored sheet;
a regulation unit configured to regulate a position of an edge portion of the stored sheet; and
a moving unit configured to move the regulation unit,
wherein the moving unit includes a moving member movable in a predetermined direction and a rotation member that is in contact with the moving member and rotatably arranged on the supporting unit,
wherein the moving member moves in the predetermined direction by rotation of the rotation member,
wherein a fixing member engageable with the moving member is attachable to the supporting unit, and
wherein, in a case where the fixing member is attached to the supporting unit, movement of the moving member in the predetermined direction is regulated by placing the moving member and the fixing member to be engaged with each other.

10. The sheet storage device according to claim 9, wherein the supporting unit is attachable to and detachable from the sheet storage device.

11. The sheet storage device according to claim 10,
wherein the supporting unit includes a bottom face portion constituting a bottom face,
wherein the bottom face portion includes a penetrated opening, and
wherein the fixing member is attached to the supporting unit in a state where the fixing member engages with the moving member via the opening.

12. The sheet storage device according to claim 11, wherein the fixing member includes a latching portion configured to be latched with a locking portion arranged on the bottom face portion.

13. The sheet storage device according to claim 12, wherein the latching portion does not expose to an exterior portion in a state where the fixing member is inserted to the opening.

14. The sheet storage device according to claim 12, wherein the rotation member is a pinion gear having a gear-shaped portion, which is configured to rotate about a shaft portion arranged on the bottom face portion.

15. The sheet storage device according to claim 14, wherein the moving member is a first moving member having a rack gear engaging with the pinion gear and is moved in a first direction through rotation of the pinion gear.

16. The sheet storage device according to claim 15, further comprising a second moving member having a rack gear engaging with the pinion gear, configured to move in a second direction opposite to the first direction,
wherein, in a case where the fixing member is attached to the supporting unit, movement in the parallel direction of the second moving member is regulated by placing the first moving member and the fixing member to be engaged with each other.

17. The sheet storage device according to claim 16, wherein the fixing member includes an engaging claw inserted into a space between claws of the rack gear and engages with the rack gear.

18. The sheet storage device according to claim 17, wherein a width dimension of the engaging claw is shorter than a width dimension of the rack gear.

19. The sheet storage device according to claim 14,
wherein a stopper which does not rotate is attached to the supporting unit in place of the pinon gear, and
wherein movement of the moving member is regulated by engagement of the stopper and the moving member.

20. The sheet storage device according to claim 12, further comprising a housing unit configured to house the fixing member in a case where the fixing member is not attached to the sheet storage device.

21. An image forming apparatus comprising:
an image forming unit configured to form a toner image;
a feeding member configured to feed a sheet to the image forming unit; and
the sheet storage device according to claim 11 configured to store the sheet fed by the feeding member.
